(19) United States
(12) Patent Application Publication
(10) Pub. No.: US 2007/0107667 A1
(43) Pub. Date: May 17, 2007

(54) Doggy eat & sleep

(76) Inventor: Wade Morris, Perris, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/282,417

(22) Filed: Nov. 17, 2005

(51) Int. Cl. A01K 1/03

(52) U.S. Cl. 119/482

(57) ABSTRACT

A combination animal house and pet feeder is disclosed. The animal house can be for any variety of pet such as a dog, cat or rabbit. The feeder is configured to integrate into the animal house by passing the feeder either through the roof of the animal house of in from a wall or side of the house. The feeder includes a self-closing mechanism that allows the feeder to be filled outside of the animal house, placed into the animal house, and once installed the feeder opens to dispense food. Alternately food may be loaded into the feeder from the top of the feeding mechanism. The dispenser is ideally suited for dispensing dry animal food, buy may alternatively or additionally include dispensers for wet food or water inside or outside of the animal house.

### FIELD OF THE INVENTION

This invention relates to a pet house with a food dispensing feeder. More particularly, the present invention relates to a house or enclosure for dog, cat, rabbit or other domesticated type animal, which further includes a food dispensing apparatus that can be either filled and placed through the roof or side of the animal house or filled from the top of the dispenser. The food dispenser can be fabricated in a self-closing arrangement so it can be placed through the animal's house without spilling any of the animal food until the food dispenser is nested within the dispensing tray. The food dispenser can also or alternatively include a water dispenser.

### BACKGROUND OF THE INVENTION

There are a number of animal houses that are available today that provide shelter from the elements and a place for pets to sleep. There are also a number of animal food dispensers that are available to provide dry food, wet food and water for pets. Animal food dispensers vary from the type where food is installed into the top of a tube and gravity dispenses the food into a bowl while it is consumed, to dispensers that open at various times to provide food while the owners are away. The animal house and the food dispenser serve two different functions and are usually located in separate locations. Exemplary patents have been issued that cover a variety of configurations for each of these products.

U.S. Pat. No. 5,746,271 issued to DeCosta, U.S. Pat. No. 5,400,743 issued to Buckley, U.S. Pat. No. 5,220,883 issued to Long, U.S. Pat. No. 5,081,956 issued to Greitzer et al., D461,024 issued to Newdoll and D328,505 issued to Perry all disclose animal shelters of various configurations. None of these patents disclose an animal feeder incorporated into the animal shelter to provide food for the pet. They further do not disclose that the feeder include a self closing apparatus to keep the.feeder closed while it is being placed within or being removed from the animal shelter.

U.S. Pat. No. 5,81 9,686 issued to Credeur, U.S. Pat. No. 4,947,796 issued to Robinette and U.S. Pat. No. 3,730,141 issued to Manning et al., all disclose gravity animal feeding mechanisms that dispense food to the animal while the food is consumed. Some of these patents disclose multiple feeding trays or watering bowls to provide both food and water for the animal. None of these patents disclose, include or describe a housing or enclosure for the animal. They further do not describe an opening that an animal can place their head through and receive food.

U.S. Pat. No. 4,248,1 75 issued to Navarro, U.S. Pat. No. 4,069,793 issued to Gower, U.S. Pat. No. 3,946,702 issued to Mazzini and U.S. Pat. No. 3,900,008 issued to Jinnette disclose animal feeding mechanisms where food is dispensed at various intervals. Mechanical and or electrical motors, gears, pulleys or similar devices are used to either rotate a tray or open a portion of the feeder to dispense food. None of these patents disclose, include or describe a housing or enclosure for the animal. They further do not describe an opening that an animal can place their head through and receive food.

What is needed is an animal shelter that further includes a feeding apparatus where the feeding apparatus can be placed through the shelter to provide feeding of the animal within the shelter. The proposed Doggy Eat & Sleep provides this solution by providing an enclosure with a food dispensing apparatus.

### BRIEF SUMMARY OF THE INVENTION

It is an object of the Doggy Eat & Sleep to provide a shelter for a pet that provides protection from the elements. The shelter allows the animal a place of safety when it is raining or windy. The shelter may further provide a place of protection from other animals. If the owner of the pet has pets of various sizes the shelter provides a refuge that prevents larger animals from entering the shelter. The shelter can be configured in a variety of shapes and may include vents windows, a roof that is removable or have other features that provide benefit to the user and the pet.

It is another object of the Doggy Eat & Sleep to provide a food dispenser that provides nourishment for a pet where the food dispenser can be placed either through the roof of the animal shelter, slides into the side of the shelter or is otherwise incorporated into the shelter such that it does not compromise the sheltering benefits of the animal's home.

It is another object of the Doggy Eat & Sleep to provide a self-closing food dispenser where the dispenser can be filled and held vertical without food falling out of the dispenser. The advantage of the self-closing feature is to allow the dispenser to be easily filled and slid into the animal's enclosure without spilling food on the ground or onto the floor of the animal's house. Once the self-closing dispenser is nested into the food dispensing bowl, the dispenser opens and food will dispense into the feeder bowl. If the dispenser is removed from the bowl, the dispenser will self close and prevent additional food from sliding into the bowl. Another option is for the dispenser to have a user operated closing mechanism that allows the operator to manually open and close the food dispenser once it is placed within the feeding bowl.

It is another object of the Doggy Eat & Sleep to provide a dispensing mechanism that provides food at selectable or pre-defined intervals. This can be accomplished with a mechanical and or electrical mechanism located on or within the feeding dispenser.

It is another object of the Doggy Eat & Sleep to provide an adjustable opening on the entry of the shelter to allow pets of a specific size access to the food. This is especially beneficial when different types of animals are at a residence and each animal has a different diet of food or different nutritional requirements.

It is still another object of the Doggy Eat & Sleep to provide a user access panel incorporated within the roof or side of the animal enclosure to allow cleaning and or maintenance of the animal shelter. This opening may be as simple as a hinged roof or removable side that can be opened allowing full access to the inside of the animal's house. Bedding can be changed and any food that falls to the floor can be removed.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a perspective view of one embodiment of the Doggy Eat & Sleep.

FIG. 2 shows a detailed isometric view of the feeding mechanism installed in the animal shelter.

FIG. 3 shows a side view of the self-closing mechanism of the food dispenser above a feeding bowl.

FIG. 4 shows a side view of the self-closing mechanism of the food dispenser engaged in a feeding bowl.

FIG. 5 shows a side view of the manual closing mechanism of the food dispenser above a feeding bowl.

FIG. 6 shows a side view of the manual closing mechanism of the food dispenser engaged in a feeding bowl.

FIG. 7 shows an isometric view of an automatic food dispenser on the feeding hopper.

FIG. 8 shows an isometric view of the adjustable animal shelter opening of the Doggy Eat & Sleep.

### DETAILED DESCRIPTION

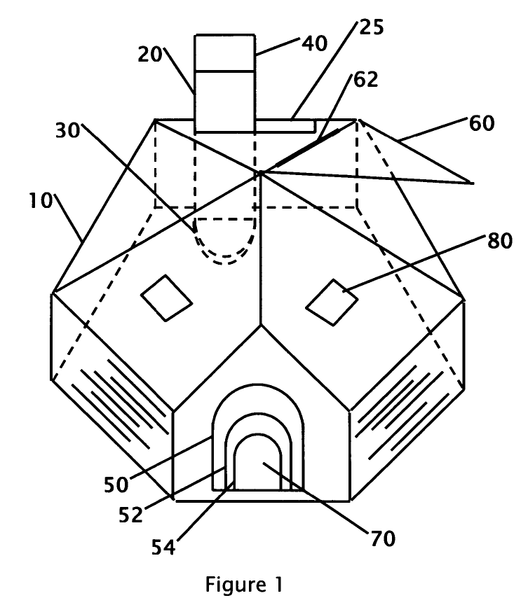

Referring to FIG. 1 that shows a perspective view of one embodiment of the Doggy Eat & Sleep 10. In this embodiment the enclosure 10 is shown as a six sided shelter. While the shelter is shown with six sides, the shelter could have as few as three sides or could be round or elliptical in exterior shape. The configuration shown is provided to disclose one contemplated embodiment that includes both an animal shelter 10 with a feeding apparatus 20. The enclosure shown includes an access door 60 that is attached to the enclosure with a hinge 62 that allows access to the interior. The access door can be used to change the bedding, or to clean the interior of the enclosure. While an access door provides additional benefit for maintenance of the interior of the enclosure, the door is not a requirement to the Doggy Eat & Sleep. Vents or skylights 80 can be included on the top or sides of the enclosure to allow for natural ventilation and or illumination to the interior of the enclosure.

The feeding apparatus 20 provides food to the interior of the enclosure. The ability to provide food on the interior of the enclosure allows the food to be protected from rain, humidity, sprinkler watering, and other animals that are too large to fit within the enclosure. The embodiment shown provides a single food dispenser 20, but also provides an area 25 for a second food or water dispenser that can be placed into the enclosure. The food dispenser 20 includes a food hopper 40 that can be filled from the top of the hopper or the hopper can be removed from the dispenser and filled externally and returned to the feeding bowl 30.

The opening of the shelter 70 can be adjusted to accommodate or restrict access to the shelter and the food. The size of the opening can be adjusted from large 50 to medium 52 to small 54 to provide a block to prevent larger animals from entering the house as well as provide protection from wind.

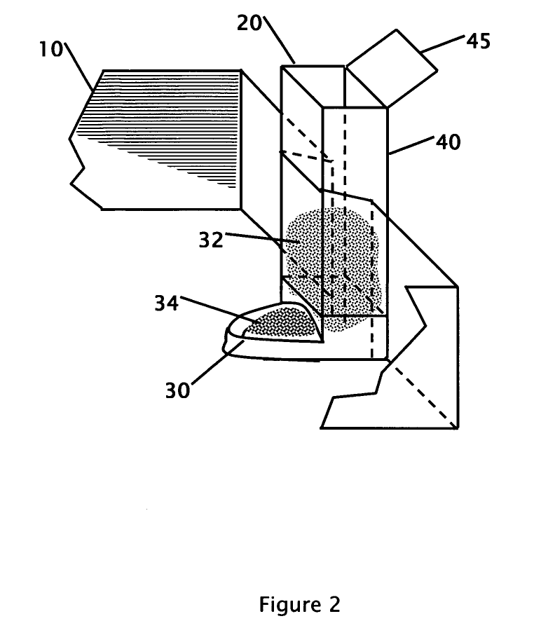

FIG. 2 shows a detailed isometric view of the feeding mechanism 20 installed in the animal shelter 10. This view shows the feeding apparatus 20 placed partially through the side wall of the enclosure. While the feeding apparatus is shown being placed partially through the side of the enclosure, other embodiments are contemplated including but not limited to placement completely through the roof, placement so only the feeding bowl 30 extends through the side of the enclosure, and where the feeding apparatus exist in a corner of the enclosure. This figure further shows the feeding apparatus hopper 40 with an openable lid 45 where food can be poured into the hopper 40. The lid is shown in this figure as a hinged opening, but the opening can be a screw down lid, cap, or other closure that prevents debris or undesirable items from entering the top of the hopper. The hopper is shown with food 32 inside of the hopper being gravity fed into the food 34 dish 30.

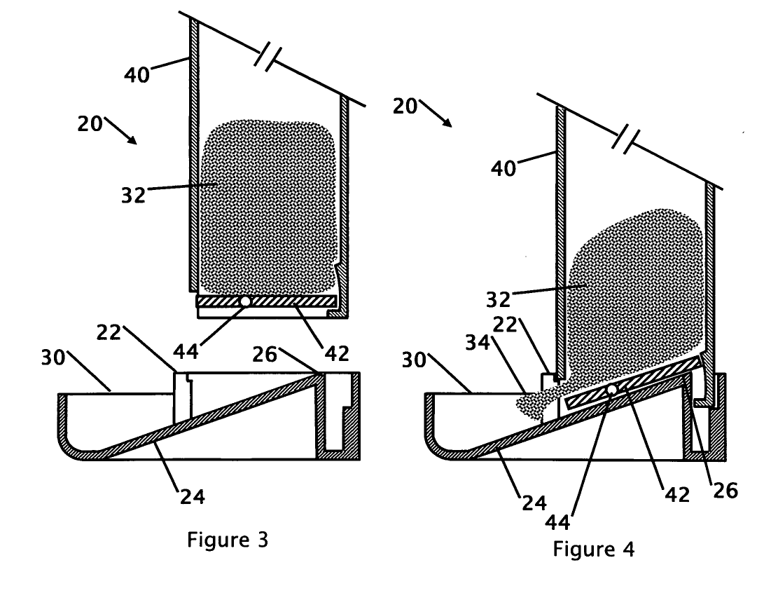

FIGS. 3 and 4 show side views of the self-closing mechanism of the food dispenser 20 both above and engaged into the feeding bowl. In FIG. 3 the hopper 40 is shown located above the feeding bowl 30. The food 32 is shown located inside the hopper. With the hopper located above the feeder bowl, the self-closing valve 42 is kept closed because more of the food 32 inside the hopper is located on the longer side of the pivot 44. This off balance pivot self closes the valve and keeps the valve closed when the hopper is removed from the feeder bowl. When the hopper 40 is brought down to engage in the stop 22 of the feeder bowl 30 the edge 26 of the incline in the feeder bowl 24 tips the flapper open, allowing the food 32 to dispense 34 into the feeding bowl. FIG. 4 shows the flapper in the tipped position allowing food to dispense from the hopper. When the hopper 40 is removed from the bowl 30, gravity and the weight of the food in the hopper closes the flapper to prevent additional food from dispensing into the bowl. With the hopper removed, food can be added, changed, emptied, or replaced without leaving excessive food in the bowl, or waiting until all the food in the hopper has been dispensed.

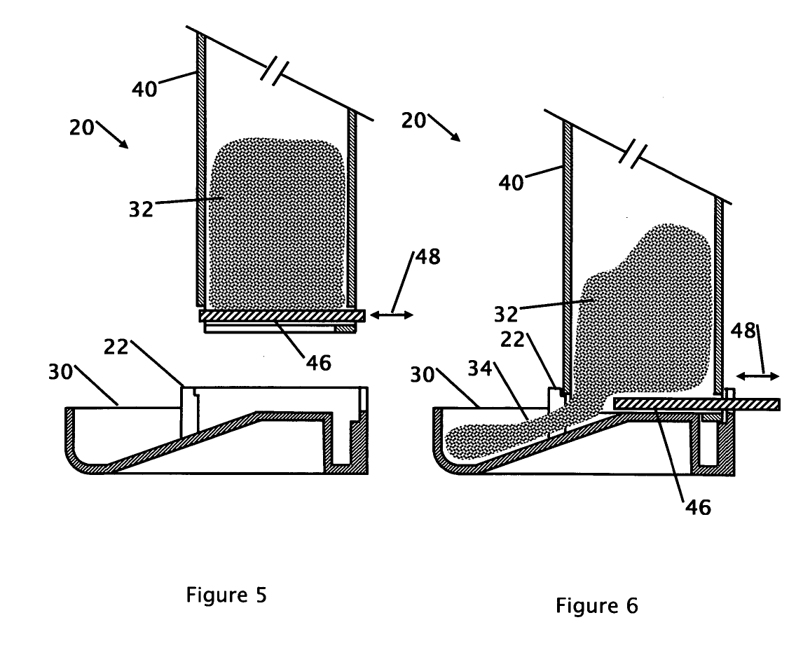

FIGS. 5 and 6 show side views of the manual closing mechanism of the food dispenser 20 both above and engaged into the feeding bowl. In FIG. 5 the hopper 40 is shown located above the feeding bowl 30. The food 32 is shown located inside the hopper. With the hopper located above the feeder bowl, the slider 46 is shown in the closed condition that keep the food in the hopper. When the hopper 40 is brought down to engage in the stop 22 of the feeder bowl 30 the slider 46 can be partially or completely slid 48 out of the bottom of the hopper 40, allowing the food 32 to dispense 34 into the feeding bowl. FIG. 6 shows the slider partially withdrawn from the hopper 40 allowing food to dispense from the hopper. Before the hopper 40 is removed from the bowl 30, the slider 46 can be pushed into the hopper to prevent additional food from dispensing into the bowl. With the hopper removed, food can be added, changed, emptied, or replaced without leaving excessive food in the bowl, or waiting until all the food in the hopper has been dispensed.

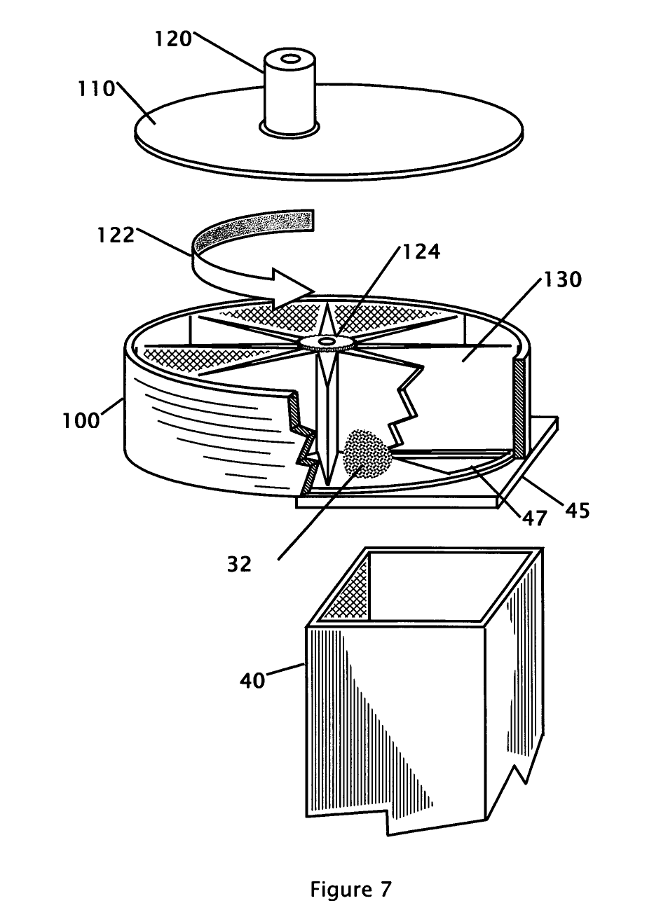

FIG. 7 shows an isometric view of an automatic food dispenser on the feeding hopper 40. This automatic feeder is intended to be located on top of the hopper 40 as a lid 45 for the hopper. This attachment provides feeding at intervals. The automatic feeding apparatus utilizes a circular dispenser 100 with flappers 130 that rotate 122 to dispense food 32 out of an opening 47 located on the bottom of the dispenser 100. A drive mechanism 120 is located on the lid 110 or side of the dispenser. The motor can be a mechanical drive motor as shown, but the dispenser could be a solenoid valve that indexes the flappers at intervals. The intervals can be based on time such as every four hours or could be programmed to dispense food at pre-defined times of the day. It is also contemplated that the dispenser can operate based upon light intensity where at sunrise and sunset food is dispensed. The motor 120 drives a gear 124 that in turn rotates the flappers 130 to push food 32 into the opening 47. In the embodiment shown eight cavities are shown to dispense food, but more or less cavities can be used to allow for more or less food dispensing events.

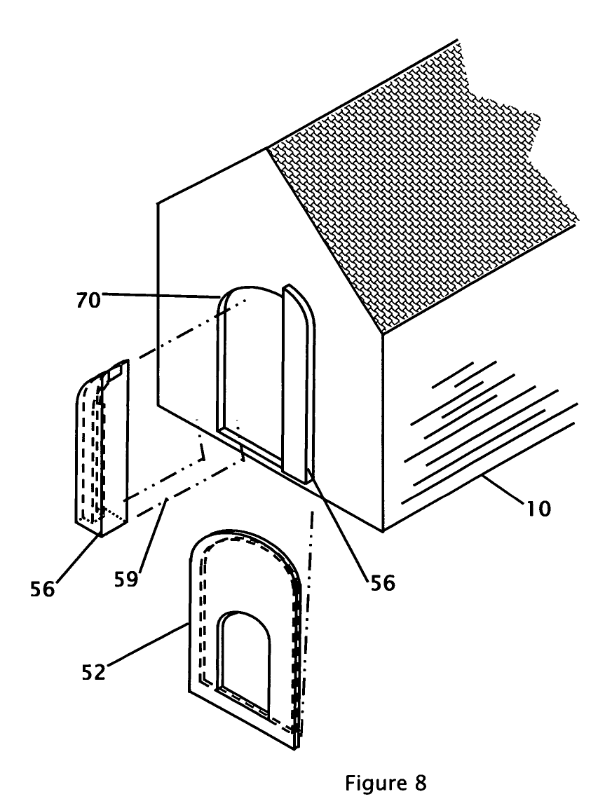

FIG. 8 shows an isometric view of the animal shelter 10 with an adjustable opening 70. The animal enclosure 10 shown in this figure is essentially rectangular in shape. The opening 70 is shown as an arched doorway, but other doorway shapes are contemplated including but not limited to square, rectangular, oval, round or a combination thereof. Because of the need to limit access to the food for larger pets, the size of the entry can be changed using shims 56 or a replaceable doorway or doorway insert 52. This is especially useful where a household has multiple animals of different sizes and the dietary requirements of each animal requires providing different food to each animal. The shims 56 consist essentially of “U” shaped members that can be placed on the sides of the doorway 70 and narrow the opening such that larger animals cannot enter the enclosure. The shims are installed by bringing them into the doorway 59 and engaging them into the sides of the doorway 70. Another contemplated method of limiting access to the interior of the enclosure is with a replacement doorway or insert 52. This insert is placed into the existing doorway to restrict access to the interior of the animal house to animals that can fit through the new smaller doorway. It is further contemplated that the doorway 70 can be made very small, and the owner of the enclosure can removed part of the doorway until the opening is large enough for access by the desired animal.

Thus, specific embodiments and applications for a doggy eat and sleep has been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An animal enclosure with food dispenser comprising:
an enclosure that provides protection from the elements designed for the benefit of a domesticated animal,
an opening in the enclosure for the placement of a gravity fed food dispenser,
a dispensing dish for dispensing the food from the gravity fed food dispenser where the dispensing dish is located within the enclosure to allow feeding of at least one domesticated animal from within the enclosure, and
the gravity fed food dispenser can be installed and removed from the enclosure through the opening.

2. The animal enclosure with food dispenser from claim 1 that further includes an opening for access of the animal.

3. The animal enclosure with food dispenser from claim 2 wherein the opening is adjustable in size to restrict access to the interior of the enclosure from larger animals that are too large to fit through the adjusted size.

4. The animal enclosure with food dispenser from claim 2 wherein the opening is adjusted by installing shims or a replacement doorway.

5. The animal enclosure with food dispenser from claim 1 wherein the enclosure is constructed from a group of materials consisting of wood, metal, fiberglass, glass, plastic or a combination thereof.

6. The animal enclosure with food dispenser from claim 1 wherein the opening for the food dispenser is located on at least one of the top, side, corner, edge of the enclosure.

7. The animal enclosure with food dispenser from claim 1 wherein the dispensing dish is removable from the enclosure and or the food dispenser.

8. The animal enclosure with food dispenser from claim 1 wherein the enclosure provides protection from the elements as well as provides protection from the elements for the food being dispensed.

9. The animal enclosure with food dispenser from claim 1 wherein the food dispenser can be removed from the dispensing dish and or the enclosure.

10. The animal enclosure with food dispenser from claim 9 wherein the food dispenser further includes a manual closing mechanism to prevent food from dispensing when the food dispenser is being installed or removed.

11. The animal enclosure with food dispenser from claim 9 wherein the food dispenser further includes a self closing and opening mechanism to prevent food from dispensing when the food dispenser is being installed or removed.

12. The animal enclosure with food dispenser from claim 9 wherein the food dispenser further includes a self closing and opening mechanism the opens when the dispenser is placed on the food dish and closes when the dispenser is removed from the food dish.

13. The animal enclosure with food dispenser from claim 1 wherein the gravity fed food dispenser can be opened from the top for filling with food.

14. The animal enclosure with food dispenser from claim 1 wherein enclosure further includes at least one partially openable side or top for access to the internal cavity of the enclosure.

15. The animal enclosure with food dispenser from claim 1 that further, includes a water dispenser.

16. The animal enclosure with food dispenser from claim 1 wherein the food dispenser includes a timing mechanism to dispense food at pre-defined intervals or times of the day.
